(19) United States
(12) Patent Application Publication
(10) Pub. No.: US 2009/0119657 A1
(43) Pub. Date: May 7, 2009

(54) Methods and systems for software upgrades

(76) Inventor: Charles M. Link, II, Atlanta, GA (US)

Correspondence Address: HUGHES TELEMATICS, INC., 41 PERIMETER CENTER EAST, SUITE 400, ATLANTA, GA, 30346, US

(21) Appl. No.: 12/258,281

(22) Filed: Oct. 24, 2008

Related U.S. Application Data
(60) Provisional application No. 60/982,285, filed on Oct. 24, 2007.

(51) Int. Cl. G06F 9/44; G06F 15/16

(52) U.S. Cl. 717/171; 717/168

(57) ABSTRACT

Before delivery, a manufacturer records module information identifying hardware modules, and corresponding software modules, installed in a vehicle. The module information includes a part number and a unique identifier for each hardware module, and name and version identifier of software loaded for each hardware module. The manufacturer, or a telematics operator, may broadcast files with upgraded software to vehicles over a wireless network. Or, upgraded software may be delivered to a vehicle via a connection between the vehicle and a computer, or a wired network. A vehicle's computer system authenticates a software file before upgrading from it by performing steps of an authentication sequence as a server in a client-server relationship with a computer device that broadcasted the file to the vehicle. A telematics system onboard the vehicle may collect and store vehicle usage information for use in determining when to upgrade from the authenticated software file.

### CROSS REFERENCE TO RELATED APPLICATION

This application claims priority under 35 U.S.C. sec. 119(e) to U.S. Provisional application 60/982,285, entitled “Methods and Systems for Software Upgrades,” which was filed on Oct. 24, 2007, and which this application incorporates in its entirety.

### TECHNOLOGY FIELD

This application relates generally to management of hardware and software modules in a vehicle, and more particularly to secure upgrading of a hardware module's software.

### BACKGROUND

Embedded controllers and microprocessors are found in multiple places in vehicles today to control vehicle systems. Many processes are in place in the automotive industry to ensure adequate testing of the embedded controllers, microprocessor, and vehicle systems before production, but these processes are not always successful. In the end, almost every vehicle manufactured needs at least one recall to correct defects in the original design.

One defect area that can require a recall includes controller and microprocessor firmware. Once a vehicle leaves the Original Equipment Manufacturer (OEM), the cost associated with upgrading the firmware can be monetarily expensive, even if the vehicle has not left the dealer's lot. Considering a vehicle that has been delivered to a customer, the implications are more significant. Not only is the OEM responsible for the upgrade, but the OEM must notify the customer and schedule a flash upgrade session with an authorized service center. The upgrade not only costs money, but it affects the image of the OEM. There is a need to reduce the cost and increase the efficiency of flash upgrades.

### SUMMARY

Disclosed are methods and systems related to software upgrades. Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE DRAWINGS

The accompanying drawings, which are incorporated in and constitute a part of this specification, illustrate embodiments and together with the description, serve to explain the principles of the methods and systems disclosed:

FIG. 1 is an exemplary VTU;

FIG. 2 is an exemplary computing device;

FIG. 3 is an exemplary method for generating shared secret keys;

FIG. 4 is an exemplary method for software upgrades;

FIG. 5 is another exemplary method for software upgrades;

FIG. 6 is an exemplary authentication method;

FIG. 7 is another exemplary authentication method; and

FIG. 8 illustrates an exemplary networked environment.

### DETAILED DESCRIPTION

Before the present methods and systems are disclosed and described, it is to be understood that the methods and systems are not limited to specific components and as such may vary. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

It is also understood that there are a number of values disclosed herein, and that each value is also herein disclosed as “about” that particular value in addition to the value itself. For example, if the value “10” is disclosed, then “about 10” is also disclosed. It is also understood that when a value is disclosed that “less than or equal to” the value, “greater than or equal to the value” and possible ranges between values are also disclosed, as appropriately understood by the skilled artisan. For example, if the value “10” is disclosed the “less than or equal to 10” as well as “greater than or equal to 10” is also disclosed. It is also understood that the throughout the application, data is provided in a number of different formats, and that this data, represents endpoints and starting points, and ranges for any combination of the data points. For example, if a particular data point “10” and a particular data point 15 are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment.

“Optional” or “optionally” means that the subsequently described event or circumstance may or, may not occur, and that the description includes instances where said event or circumstance occurs and instances where it does not.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments of the methods and systems and the Examples included therein and to the Figures and their previous and following description.

Automobiles today contain a large number of embedded controllers controlling everything from the engine and transmission to the entertainment system and beyond. Embedded controllers serve safety-critical functions in an ever-increasing range of automotive electronics. Embedded software, such as firmware, provides increased functionality, efficiency, and flexibility, but it introduces complex failure modes. Some of these failure modes are not discovered until the vehicle is in the hands of the consumer. Upgrading the firmware contained in these controllers is inexpensive in the factory environment but once the vehicle leaves the factory floor, the cost to upgrade the firmware becomes significantly larger. Even with the systems developed to communicate to all the various modules inside of the car, upgrading the firmware requires an automotive service specialist to actually “touch” the car to upgrade the firmware in one or more modules. Because of the safety aspects of many of these controllers, it is imperative that the upgrades be completed on a timely and thorough basis. Some National Highway Traffic Safety Administration (NTSA) mandated recalls require full accountability, a positive confirmation of the upgrade is necessary. The methods and systems described herein can deliver vehicle flash upgrades in a secure manner and can provide a positive confirmation of a successful upgrade. In one aspect, the methods and systems can deliver software upgrades on a broadcast basis over an insecure communications channel with individual validation, authentication, confirmation, and subsequent update on a remote basis for a low per unit cost while maintaining full control and compliance with regulatory requirements.

Requirements for upgrading firmware in a vehicle can fall into three categories: safety related enhancement, pollution related enhancements, and function related enhancements. Each category can have an associated level of importance. For example, correction of engine computer or anti-lock braking system functionality is more important than a minor tweak to the vehicle entertainment system. Because of the functions controlled by some of the microprocessors within a vehicle, in some aspects, validation and authentication is required before a software upgrade is attempted.

Vehicles are equipped with a variety of safety, information and entertainment electronics. Almost every vehicle manufactured today contains sonie type of radio receiver for entertainment. Though all of those receivers contain capability to receive AM and FM broadcasts on the standard frequencies used for that purposes, many now contain Satellite Digital Audio Receiver System (SDARS) receivers that receive digital data streams containing many audio entertainment and digital information streams. The typical SDARS receiver in the U.S. can receive about 12 million bits per second which may or may not be wholly broadcast from a high power satellite. Depending on the exact system and network engineering, some portion of the SDARS bandwidth may be received from terrestrial stations to offer better signal coverage and allow penetration in the urban canyons of the typical metropolitan city. AM and FM broadcasters are working to adapt to more advanced technologies to remain competitive. One of the latest innovations in the broadcasting field is digital transmission technologies that utilize similar bandwidths and deliver higher quality content. The technologies, whether analog or digital can support distribution of alternate content aside from the main audio channel.

Vehicles can also be equipped with telematics equipment. For example, a device such as a Vehicle Telematics Unit (VTU), can be used to report crashes, roadway emergencies, concierge services, transmit vehicle data, etc. A VTU can comprise a wireless communications device such as a cellular or PCS communications device and a GPS to accomplish many of the features of the VTU.

In an aspect, provided is an apparatus comprising a telematics control unit configured for secure software upgrades. The apparatus can be installed in a vehicle. Such vehicles include, but are not limited to, personal and commercial automobiles, motorcycles, transport vehicles, watercraft, aircraft, and the like. For example, an entire fleet of a vehicle manufacturer's vehicles can be equipped with the apparatus. The apparatus 101, is also referred to herein as the VTU 101. The apparatus can perform any of the methods disclosed herein in part and/or in their entireties.

All components of the telematics unit can be contained within a single box and controlled with a single core processing subsystem or can be comprised of components distributed throughout a vehicle. Each of the components of the apparatus can be separate subsystems of the vehicle, for example, a communications component such as a Satellite Digital Audio Radio Service (SDARS), or other satellite receiver, can be coupled with an entertainment system of the vehicle.

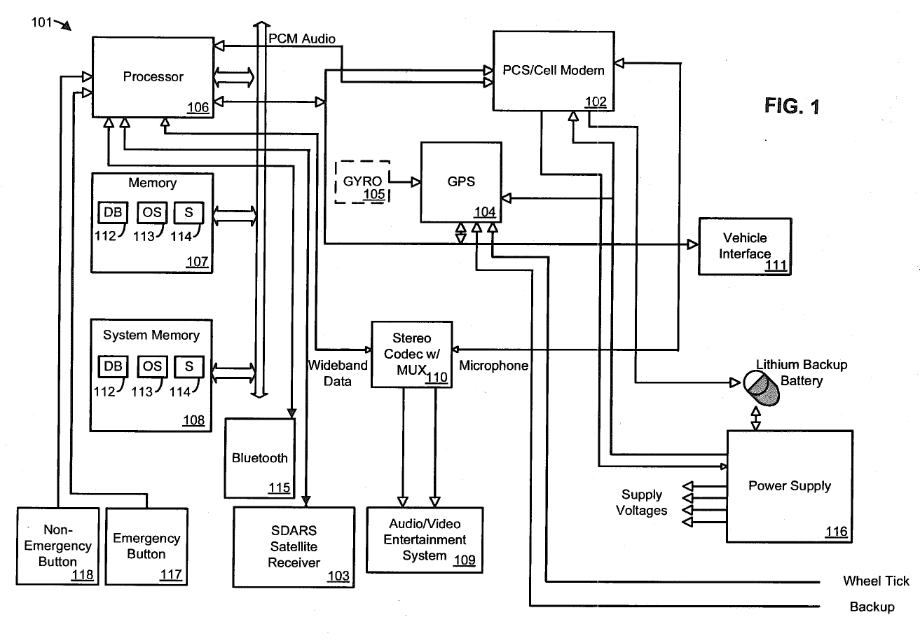

An exemplary apparatus 101 is illustrated in FIG. 1. This exemplary apparatus is only an example of an apparatus and is not intended to suggest any limitation as to the scope of use or functionality of operating architecture. Neither should the apparatus be necessarily interpreted as having any dependency or requirement relating to any one or combination of components illustrated in the exemplary apparatus. The apparatus 101 can comprise one or more communications components. Apparatus 101 illustrates communications components (modules) PCS/Cell Modem 102 and SDARS receiver 103. These components can be referred to as vehicle mounted transceivers when located in a vehicle. PCS/Cell Modem 102 can operate on any frequency available in the country of operation, including, but not limited to, the 850/1900 MHz cellular and PCS frequency allocations. The type of communications can include, but is not limited to GPRS, EDGE, UMTS, 1×RTT or EV-DO. The PCS/Cell Modem 102 can be a Wi-Fi or mobile Worldwide Interoperability for Microwave Access (WIMAX) implementation that can support operation on both licensed and unlicensed wireless frequencies. The apparatus 101 can comprise an SDARS receiver 103 or other satellite receiver. SDARS receiver 103 can utilize high powered satellites operating at, for example, 2.35 GHz to broadcast digital content to automobiles and some terrestrial receivers, generally demodulated for audio content, but can contain digital data streams.

PCS/Cell Modem 102 and SDARS receiver 103 can be used to update an onboard database 112 contained within the apparatus 101. Updating can be requested by the apparatus 101, or updating can occur automatically. For example, database updates can be performed using FM subcarrier, cellular data download, other satellite technologies, Wi-Fi and the like. SDARS data downloads can provide the most flexibility and lowest cost by pulling digital data from an existing receiver that exists for entertainment purposes. An SDARS data stream is not a channelized implementation (like AM or FM radio) but a broadband implementation that provides a single data stream that is separated into useful and applicable components.

GPS receiver 104 can receive position information from a constellation of satellites operated by the U.S. Department of Defense. Alternately, the GPS receiver 104 can be a GLONASS receiver operated by the Russian Federation Ministry of Defense, or any other positioning device capable of providing accurate location information (for example, LORAN, inertial navigation, and the like). GPS receiver 104 can contain additional logic, either software, hardware or both to receive the Wide Area Augmentation System (WAAS) signals, operated by the Federal Aviation Administration, to correct dithering errors and provide the most accurate location possible. Overall accuracy of the positioning equipment subsystem containing WAAS is generally in the two meter range. Optionally, the apparatus 101 can comprise a MEMS gyro 105 for measuring angular rates and wheel tick inputs for determining the exact position based on dead-reckoning techniques. This functionality is useful for determining accurate locations in metropolitan urban canyons, heavily tree-lined streets and tunnels.

One or more processors 106 can control the various components of the apparatus 101. Processor 106 can be coupled to removable/non-removable, volatile/non-volatile computer storage media. By way of example, FIG. 1 illustrates memory 107, coupled to the processor 106, which can provide non-volatile storage of computer code, computer readable instructions, data structures, program modules, and other data for the device 101, which may be referred to herein as a vehicle telematics control unit, or a vehicle telematics unit (“VTU”). For example and not meant to be limiting, memory 107 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

The processing of the disclosed systems and methods can be performed by software components. The disclosed system and method can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed method can also be practiced in grid-based and distributed computing environments where tasks are performed by remote processing devices that are linked through a communications network. In a distributed computing environment, program modules can be located in both local and remote computer storage media including memory storage devices.

Any number of program modules can be stored on the memory 107, including by way of example, an operating system 113 and software 114. Each of the operating system 113 and software 114 (or some combination thereof) can comprise elements of the programming and the software 114. Data can also be stored on the memory 107 in database 112. Database 112 can be any of one or more databases known in the art.

Examples of such databases comprise, DB2®, Microsoft® Access, Microsoft® SQL Server, Oracle®, mySQL, PostgreSQL, and the like. The database 112 can be centralized or distributed across multiple systems. The software 114 can comprise upgrade software 206 and the data can comprise upgrade data.

By way of example, the operating system 113 can be a Linux (Unix-like) operating system. One feature of Linux is that it includes a set of “C” programming language functions referred to as, “NDBM”. NDBM is an API for maintaining key/content pairs in a database which allows for quick access to relatively static information. NDBM functions use a simple hashing function to allow a programmer to store keys and data in data tables and rapidly retrieve them based upon the assigned key. A major consideration for an NDBM database is that it only stores simple data elements (bytes) and requires unique keys to address each entry in the database. NDBM functions provide a solution that is among the fastest and most scalable for small processors. Although Linux may be one example of operating system code, module 101 may use other operating systems, including proprietary systems written by a manufacturer of system 101.

It is recognized that such programs and components may reside at various times in different storage components of the apparatus 101, and are executed by the processor 106 of the apparatus 101. Alternatively, in the context of a vehicle computer system, a vehicle's computer system may use multiple hardware modules, each for performing a certain operation, and they may all communicate with a main hardware module via a bus, which vehicle interface 111 may communicate with. For example, a vehicle may use separate hardware modules for power windows, for power seats, for air bag monitoring and deployment, for engine control, for transmission control, for radio, for tire pressure monitoring, for anti lock braking, for traction control, for climate control, and many other function. Each hardware module that performs, monitors, controls, or is otherwise involved in these functions typically includes a processor like 106, one, or more, memories like 107 and 108, and couples to the other hardware modules and to a main controller (typically the engine control module, or “ECM”) via a controller area network (“CAN”), which may couple to interface 111. Accordingly, all of the various hardware modules use and access, and perhaps store, software (which may be referred to herein as a software module, or modules) that hardware modules use to perform their function.

An implementation of reporting software 114 can be stored on or transmitted across some form of computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any method or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

Continuing with discussion of FIG. l, the figure illustrates system memory 108, coupled to the processor 106, which c an comprise computer readable media in the form of volatile memory, such as random access memory (RAM, SDRAM, and the like), and/or non-volatile memory, such as read only memory (ROM). The system memory 108 typically contains data and/or program modules such as operating system 113 and software 114 that are immediately accessible to and/or are presently operated on by the processor 106. The operating system 113 can comprise a specialized task dispatcher, slicing available bandwidth among the necessary tasks at hand, including communications management, position determination and management, entertainment radio management, SDARS data demodulation and assessment, power control, and vehicle communications.

The processor 106 can control additional components within the apparatus 101 to allow for ease of integration into vehicle systems. The processor 106 can control power to the components within the apparatus 101, for example, shutting off GPS receiver 104 and SDARS receiver 103 when the vehicle is inactive, and alternately shutting off the PCS/Cell Modem 102 to conserve the vehicle battery when the vehicle is stationary for long periods of inactivity. The processor 106 can also control an audio/video entertainment subsystem 109 and comprise a stereo codec and multiplexer 110 for providing entertainment audio and video to the vehicle occupants, for providing wireless communications audio (PCS/Cell phone audio), speech recognition from the driver compartment for manipulating the SDARS receiver 103 and PCS/Cell Modem 102 phone dialing, and text to speech and pre-recorded audio for vehicle status annunciation.

Hardware apparatus 101 can interface and monitor various other vehicle system hardware apparatuses, or modules, and sensors to determine and control vehicle conditions. Apparatus 101 can interface with the vehicle's other hardware through a vehicle interface 111. The vehicle interface 111 can include, but is not limited to, OBD (On Board Diagnostics) port, OBD-11 port, CAN (Controller Area Network) port, and the like. The vehicle interface 111, allows the apparatus 101 to receive data indicative of vehicle performance, such as vehicle trouble codes, operating temperatures, operating pressures, speed, fuel air mixtures, oil quality, oil and coolant temperatures, wiper and light usage, mileage, break pad conditions, and any data obtained from any discrete sensor that contributes to the operation of the vehicle engine and drive-train computer. Additionally CAN interfacing can eliminate individual dedicated inputs to determine brake usage, backup status, and it can allow reading of onboard sensors in certain vehicle stability control modules providing gyro outputs, steering wheel position, accelerometer forces and the like for determining driving characteristics. The apparatus 101 can interface directly with a vehicle subsystem or a sensor, such as an accelerometer, gyroscope, airbag deployment computer, and the like. Data obtained from, and processed data derived from, the various vehicle systems and sensors can be transmitted to a central monitoring station (central server) via the PCS/Cell Modem 102. In a typical embodiment, a central computer server may be located at a telematics operation center (“TOC”). A TOC typically includes a server (or computer that can operate and control the server if the server is remotely located from the TOC) coupled to the internet and that also couples to a wireless communication network that communicates with the onboard computer systems of multiple vehicles. The computer server at the TOC may store, access, operate on, retrieve data from, and update records in, a module data base that associates information related to a plurality of vehicle modules with an identifier of the vehicle in which they are installed.

Communication with a vehicle driver can be through an infotainment (radio) head (not shown) or other display device (not shown). More than one display device can be used. Examples of display devices include, but are not limited to, a monitor, an LCD (Liquid Crystal Display), a projector, and the like.

The apparatus 101 can receive power from power supply 116. The power supply can have many unique features necessary for correct operation within the automotive environment. One mode is to supply a small amount of power (typically less than 100 microamps) to at least one master controller that can control all the other power buses inside of apparatus 101, a vehicle telematics unit (“VTU”) for example. In an exemplary system, a low power low dropout linear regulator supplies this power to PCS/Cellular modem 102. This provides the static power to maintain internal functions so that it can await external user push-button inputs or await CAN activity via vehicle interface l11. Upon receipt of an external stimulus via either a manual push button or CAN activity, the processor contained within the PCS/Cellular modem 102 can control the power supply 116 to activate other functions within the VTU 101, such as GPS 104/GYRO 105, Processor 106/Memory 107 and 108, SDARS receiver 103, audio/video entertainment system 109, audio codec multiplexer 110, and any other peripheral within the VTU 101 that does not require standby power.

In an exemplary system, there can be a plurality of power supply states. One state can be a state of full power and operation, selected when the vehicle is operating. Another state can be a full power relying on battery backup. It can be desirable to turn off the GPS and any other non-communication related subsystem while operating on the back-up batteries. Another state can be when the vehicle has been shut off recently, perhaps within the last 30 days, and the system maintains communications with a two-way wireless network for various auxiliary services like remote door unlocking and location determination messages. After the recent shut down period, it is desirable to conserve the vehicle battery by turning off almost all power except the absolute minimum in order to maintain system time of day clocks and other functions, waiting to be awakened on CAN activity. Additional power states are contemplated, such as a low power wakeup to check for network messages, but these are nonessential features to the operation or the VTU.

Normal operation can comprise, for example, the PCS/Cellular modem 102 waiting for an emergency pushbutton key-press or CAN activity. Once either is detected, the PCS/Cellular modem 102 can awaken and enable the power supply 116 as required. Shutdown can be similar wherein a first level shutdown turns off everything except the PCS/Cellular modem 102, for example. The PCS/Cellular modem 102 can maintain wireless network contact during this state of operation. The VTU 101 can operate normally in the state when the vehicle is turned off. If the vehicle is off for an extended period of time, perhaps over a vacation etc., the PCS/Cellular modem 102 can be dropped to a very low power state where it no longer maintains contact with the wireless network.

Additionally, in FIG. 1, subsystems can include a BlueTooth transceiver 115 that can be provided to interface with occupant supplied devices such as phones, headsets, and music players. Emergency button 117 can be coupled to the processor 106. The emergency button 117 can be located in a vehicle cockpit and activated an occupant of the vehicle. Activation of the emergency button 117 can cause processor 106 to initiate a voice and data connection from the vehicle to a central monitoring station, also referred to as a remote call center. Data such as GPS location and occupant personal information can be transmitted to the call center. The voice connection permits two way voice communication between a vehicle occupant and a call center operator located at the TOC. The call center operator can have local emergency responders dispatched to the vehicle based on the data received. In another embodiment, the connections are made from the vehicle to an emergency responder center.

One or more non-emergency buttons 118 can be coupled to the processor 106. One or more non-emergency buttons 118 can be located in a vehicle cockpit and activated by an occupant of the vehicle. Activation of the one or more non-emergency buttons 118 can cause processor 106 to initiate a voice and data connection from the vehicle to a remote call center. Data such as GPS location and occupant personal information can be transmitted to the call center. The voice connection permits two way voice communications between a vehicle occupant and a call center operator. The call center operator can provide location based services to the vehicle occupant based on the data received and the vehicle occupant's desires. For example, a button can provide a vehicle occupant with a link to roadside assistance services such as towing, spare tire changing, refueling, and the like. In another embodiment, a button can provide a vehicle occupant with concierge-type services, such as local restaurants, their locations, and contact information; local service providers their locations, and contact information; travel related information such as flight and train schedules; and the like.

For any voice communication made through the VTU 101, text-to-speech algorithms can be used so as to convey predetermined messages in addition to or in place of a vehicle occupant speaking. This allows for communication when the vehicle occupant is unable or unwilling to communicate vocally.

VTU 101 can communicate with one or more computers, either through direct wireless communication and/or through a network such as the Internet. Such communication can facilitate data transfer, voice communication, and the like. One skilled in the art will appreciate that what follows is a functional description of an exemplary operating environment and that functions can be performed by software, by hardware, or by any combination of software and hardware.

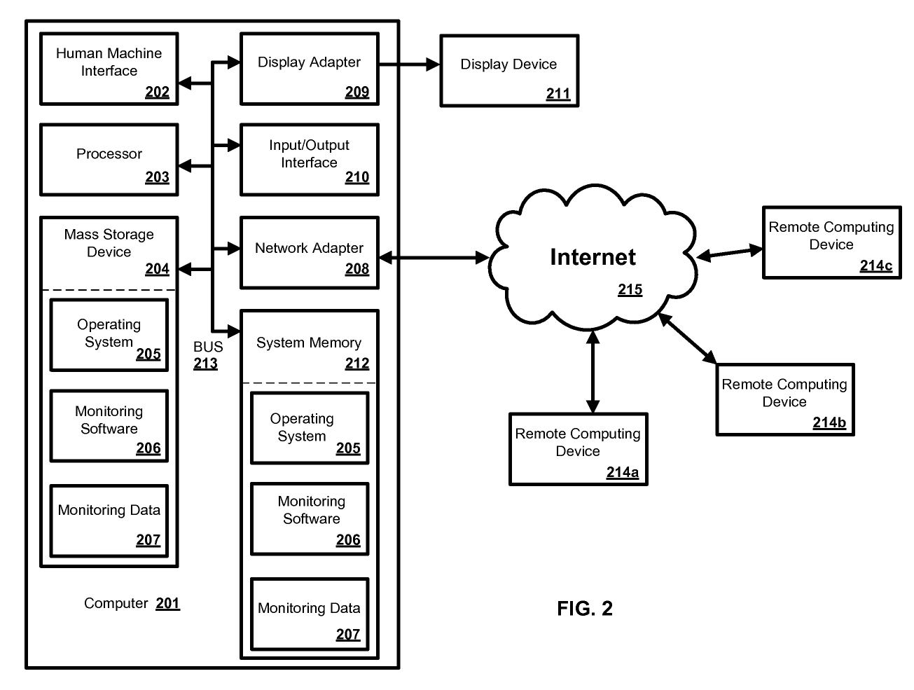

FIG. 2 is a block diagram illustrating an exemplary operating environment for performing the disclosed methods. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The methods and systems can be operational with numerous other general purpose or special purpose computing system environments or configurations. Examples of well known computing systems, environments, and/or configurations that can be suitable for use with the system and method comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

In another aspect, the methods and systems can be described in the general context of computer instructions, such as program modules, being executed by a computer. Generally, program modules comprise routines, programs, objects, components, data structures, etc. that perform particular tasks or implement particular abstract data types. The methods and systems can also be practiced in distributed computing environments where tasks are performed by remote processing devices that are linked through a communications network. In a distributed computing environment, program modules can be located in both local and remote computer storage media including memory storage devices.

Further, one skilled in the art will appreciate that the system and method disclosed herein can be implemented via a general-purpose computing device in the form of a computer 201. The components of the computer 201 can comprise, but are not limited to, one or more processors or processing units 203, a system memory 212, and a system bus 213 that couples various system components including the processor 203 to the system memory 212.

The system bus 213 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI) bus also known as a Mezzanine bus. The bus 213, and all buses specified in this description can also be implemented over a wired or wireless network connection and each of the subsystems, including the processor 203, a mass storage device 204, an operating system 205, upgrade software 206, upgrade data 207, a network adapter (or communications interface) 208, system memory 212, an Input/Output Interface 210, a display adapter 209, a display device 211, and a human machine interface 202, can be contained within one or more remote computing devices 214a,b,c at physically separate locations, connected through buses of this form, in effect implementing a fully distributed system. In one aspect, a remote computing device can be a VTU 101.

The computer 201 typically comprises a variety of computer readable media. Exemplary readable media can be any available media that is accessible by the computer 201 and comprises, for example and not meant to be limiting, both volatile and non-volatile media, removable and non-removable media. The system memory 212 comprises computer readable media in the form of volatile memory, such as random access memory (RAM), and/or non-volatile memory, such as read only memory (ROM). The system memory 212 typically contains data such as upgrade data 207 and/or program modules such as operating system 205 and upgrade software 206 that are immediately accessible to and/or are presently operated on by the processing unit 203. Upgrade data 207 can comprise any data generated by, generated for, received from, or sent to the VTU.

In another aspect, the computer 201 can also comprise other removable/non-removable, volatile/non-volatile computer storage media. By way of example, FIG. 2 illustrates a mass storage device 204 which can provide non-volatile storage of computer code, computer readable instructions, data structures, program modules, and other data for the computer 201. For example and not meant to be limiting, a mass storage device 204 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 204, including by way of example, an operating system 205 and upgrade software 206. Each of the operating system 205 and upgrade software 206 (or some combination thereof) can comprise elements of the programming and the upgrade software 206. Upgrade data 207 can also be stored on the mass storage device 204. Upgrade data 207 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems.

In another aspect, the user can enter commands and information into the computer 201 via an input device (not shown). Examples of such input devices comprise, but are not limited to, a keyboard, pointing device (e.g., a “mouse”), a microphone, a joystick, a scanner, tactile input devices such as gloves, and other body coverings, and the like. These and other input devices can be connected to the processing unit 203 via a human machine interface 202 that is coupled to the system bus 213, but can be connected by other interface and bus structures, such as a parallel port, game port, an IEEE 1394 Port (also known as a Firewire port), a serial port, or a universal serial bus (USB).

In yet another aspect, a display device 211 can also be connected to the system bus 213 via an interface, such as a display adapter 209. It is contemplated that the computer 201 can have more than one display adapter 209 and the computer 201 can have more than one display device 211. For example, a display device can be a monitor, an LCD (Liquid Crystal Display), or a projector. In addition to the display device 211, other output peripheral devices can comprise components such as speakers (not shown) and a printer (not shown) which can be connected to the computer 201 via Input/Output Interface 210.

The computer 201 can operate in a networked environment using logical connections to one or more remote computing devices 214a,b,c. By way of example, a remote computing device can be a personal computer, portable computer, a server, a router, a network computer, a VTU 101, a PDA, a cellular phone, a “smart” phone, a wireless communications enabled key fob, a peer device or other common network node, and so on. Logical connections between the computer 201 and a remote computing device 214a,b,c can be made via a local area network (LAN) and a general wide area network (WAN). Such network connections can be through a network adapter 208. A network adapter 208 can be implemented in both wired and wireless environments. Such networking environments are conventional and commonplace in offices, enterprise-wide computer networks, intranets, and the Internet 215. In one aspect, the remote computing device 214a,b,c can be one or more VTU 101's.

For purposes of illustration, application programs and other executable program components such as the operating system 205 are illustrated herein as discrete blocks, although it is recognized that such programs and components reside at various times in different storage components of the computing device 201, and are executed by the data processor(s) of the computer. An implementation of upgrade software 206 can be stored on or transmitted across some form of computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any method or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems provided can deliver the required capability, flexibility, and economy for a nationwide firmware upgrade system. The system described herein can merge the available resources of a wide area data distribution system (for example, satellite based) along with a digital communications device (for example, digital cell/pcs phone) to deliver fully validated, authenticated and confirmed firmware upgrades to target vehicles at low price points. In one aspect, the methods and systems can utilize the unused “automatic crash notification” (ACN) capability of a VTU to deliver firmware upgrades.

In one aspect, the methods and systems can combine a vehicle's entertainment/information equipment and telematics equipment. Utilizing the synergies of a GPS, display screen, wireless transceiver, and entertainment system, a next generation “infotainment” system can be created. This infotainment system yields a platform for delivering software upgrades to various subsystems within the vehicle, in some aspects utilizing available bandwidth of SDARS or other satellite or terrestrial broadcasts that may be underutilized at certain times of the day.

In one aspect, a VTU can communicate with other processors in a vehicle, for example through an internal bus, such as a CAN bus as discussed above. The internal bus can be used for communications between and among all the various computer hardware modules, and their associated memories and processors contained within the vehicle. The bus can be used for a variety of vehicle communications, both safety-critical (engine and brake control, for example) and convenience and comfort related (radio/seat/window control).

When a manufacturer prepares a completed vehicle for delivery from the factory to a dealer, the manufacture can poll, via the vehicle interface 111, as shown in FIG. 1, the hardware modules installed in the vehicle. In response to the polling request, each of the various modules returns module information associated with itself. The module information that the hardware modules return may include hardware module model number, software module name and version number, and hardware module serial number, which would be an example of a unique identifier of the hardware module. The module information returned in response to the module information request may be stored in a vehicle module table in one of the memories of one of the vehicles hardware modules. After the manufacturer polls the hardware modules with a computer device coupled to the vehicle interface, the manufacturer can transmit the hardware module information from the module information table to the central computer at the TOC. Alternatively, the manufacturer can transmit the module information for each vehicle to a local computer storage device.

Regardless of where the manufacturer transmits the polled module information to, the manufacturer may aggregate the module information for all of the vehicles it manufactures into a master module information table, or database.

At startup and/or periodically, the VTU can poll other computers, or hardware modules, via the common bus to determine the software name and current software version associated with each hardware module. In addition, the VTU can determine the serial number of each hardware module installed in the vehicle periodically, upon start-up, or according to another schedule. This can be performed each time the vehicle is started or once per interval, such as daily, weekly, monthly etc. Since a vehicle's VTU can store the module information for the modules installed in it, the VTU can facilitate updating of the master module database at either a manufacturers central storage location, or, alternatively, at the TOC, which may, or may not be, operated by a vehicle's manufacturer..

In addition to generating module information for a master module information database, a vehicle's VTU may also receive software upgrades to the software modules that are currently loaded for the various modules installed in a vehicle. The software upgrades may be received via a communication network such as a wireless network, or even a computer device coupled to a local area network with internet access. Regardless of the network the vehicle's VTU receives software upgrades over, the VTU preferably receives the upgrades via vehicle interface 111 shown in FIG. 1. However, before overwriting currently installed software modules with just-received software modules purporting to be upgraded compared with the existing versions, the VTU begins an authentication sequence to determine whether the upgrade module is legitimate or not (e.g., malicious software received from a hacker attempting to harm or disable the vehicle hardware modules.)

In some aspects, to facilitate the authentication sequence, each VTU can be built with secret keys known only to the manufacturer. These keys can be stored into permanent boot block memory of the VTU and not externally readable or modifiable outside of the VTU manufacturing environment. For example, there can be eight keys of eight bytes. Other quantities of keys and sizes of keys are specifically contemplated. In some aspects, these keys are not passed over the air nor displayed or rendered readable externally to the VTU or any associated peripheral.

In an aspect, a method generates working keys. A VTU can be enabled by installing a Subscriber Identity Module (SIM) card or other identifying element into the VTU or the VTU can be programmed with a unique network number. The unique network number is the equivalent of a mobile identification number (“MIN”) in a CDMA cell phone or an International Mobile Station Identifier (IMSI) in a GSM cellphone. The VTU can determine a VIN over an in-vehicle bus, such as a CAN bus. The VIN can be stored in memory within the VTU. The VTU can be queried, either over the public wireless network or over a specialized internal RF system that resembles a one cell wireless system. The query can return the IMSI or phone number equivalent, the VIN and a VTU serial number. This information can be sent to a central server.

In one aspect, a vehicle's computer systems may store one, or more, identifiers unique to the vehicle, such as, for example, a VIN, an IMSI, a serial number associated with the VTU, and a predetennined number of shared secret data (“SSD”), or shared secret keys, embedded in the VTU at the time of manufacture of the VTU. For example, the SSD can comprise ten 8-byte (64 bit) keys, so that a different SSD can be used during each year of a vehicle's ten year projected life. The SSDs can be configured so as not to be readable by any external source and stored in permanent, non-reprogrammable boot block flash memory within the VTU. A central server also stores the same SSD and associates them in a database with an identifier of a corresponding vehicle's VTU, as discussed above.

The central server, either at the TOC, or at another central location (perhaps operated by the vehicle's manufacturer) can merge the SSD with the VIN and/or IMSI or phone number equivalent according to an algorithm. The result of combining the SSD and other information according to the algorithm, may be referred to as a ‘working key’ and can be used for software upgrades to the vehicle systems, including the VTU itself.

After merging the data values, the central server can attempt to establish ‘working keys.’ An important aspect of software upgrades is security and timing. If someone has enough patience, security can be compromised. In another aspect, an actual SSD key can be used as a key of last resort. The SSD key can be used to change and validate working keys. In this aspect, the SSD key can be combined with other specific information to generate the working keys, which can be generated and changed as system operators deem necessary.

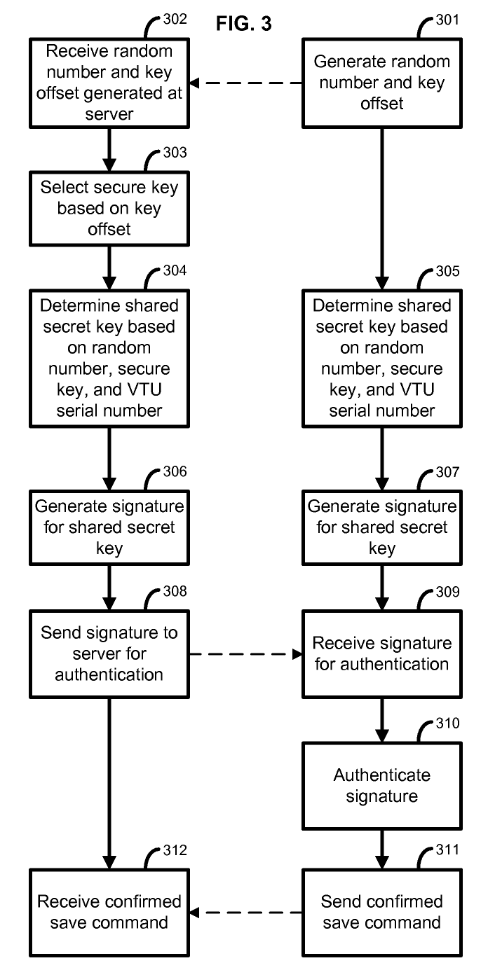

In one aspect, illustrated in FIG. 3, a random number can be generated by the central server and passed to the VTU along with a key offset at 301. A key offset may correspond to one key of the set of predetermined number of SSD keys. For example, key offsets 0, 1, . . . 9, may each refer to one key of the set of SSD keys, the set of SSD keys including key 0, key 1, . . . key 9, respectively. These numbers have been chosen for purposes of illustration; for example, key offset 0 refers to key 0, which may be used for software upgrades performed during year 2010, key offset 1 and key 1 for upgrades during 2011, etc.

Thus, the central server generates a random number and sends it and a key offset to the VTU. The central server also calculates a working key from the random number and the SSD key corresponding to the key offset sent to the VTU. The VTU receives the random number and the offset from the central server, and selects the SSD key from the set of SSD keys stored in it at the time of manufacture. Using the same algorithm that the central server used, the VTU calculates a working key using the random number received from the central server and the SSD key that corresponds to the key offset received from the central server.

During this process, the central server can be configured to not communicate the VTU serial number or any other information used to generate the working keys. The random number can be any length desired, for example, a 56 bit random number can be used. At 302, the VTU receives the random number and key offset. The VTU selects the secure key based on the key offset at 303. The VTU, at 304, and the server, at 305, can determine one or more new 64 bit working keys based on a predetermined algorithm, such as a hashing, checksum and/or cryptographic algorithm.

The VTU, at 306, and the central server at 307, can generate an 18 bit signature for the working key The VTU can transmit the signature to the central server at 308. The central server can receive the signature at 309. At 310, the central server can authenticate the received signature(s) by determining if the server-calculated signature values match the received signature values. If the VTU and central server perform the steps in the scenario as described above, the central server performs the roles of a server in the authentication sequence. If the roles performed in steps 308, 309, and 310 are reversed with respect to the VTU and central server, the VTU assumes the authentication sequence role of a server in a client-server relationship. The central server can issue a confirmed save command to the VTU at 311. The VTU can receive and implement the confirmed save command at 312.

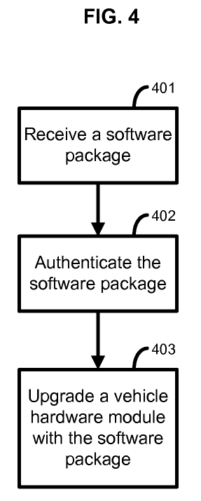

In an aspect, illustrated in FIG. 4, provided are methods for software upgrades comprising receiving a software package at 401, authenticating the software package at 402, and upgrading a vehicle hardware module at 403. The receiver can be, for example, a PCS/Cell modem, a satellite receiver, FM radio receiver, wi-fi, and the like. Upgrading a hardware module can be performed over an in-vehicle bus.

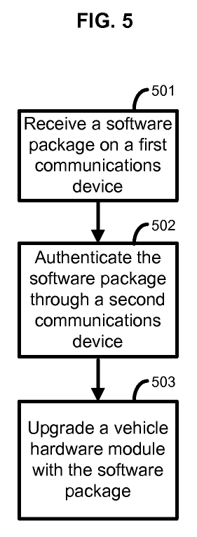

In another aspect, illustrated in FIG. 5, provided are methods for software upgrades comprising receiving a software package on a first communications device at 501, authenticating the software package through a second communication device at 502, and upgrading a vehicle hardware module at 503. The first communications device can be, for example, a satellite receiver. The second communications device can be, for example, a PCS/Cell modem. Upgrading a hardware module can be performed over an in-vehicle bus. For example, the VTU can upgrade an engine controller through a CAN bus.

In one aspect, a first communications device, such as an SDARS receiver, can be used to download software data. A second communications device, such as a PCS/Cell Modem, can be used for communicating security, validation and authentication information to a central server. An SDARS signal is generally demodulated for audio content, but can contain digital data streams that can be used to download new processor software in object code format to re-flash the various remote processors within the vehicle. Software updates can be provided using FM subcarrier, cellular data download, digital content on IBOC stations, other satellite technologies, or Wi-Fi etc. Of theses, SDARS data downloads provide the most flexibility and lowest cost by pulling digital data from an existing receiver already installed for the purpose of audio entertainment. The methods and systems provided can extract software for re-flashing the onboard processors from an SDARS data stream. In a further aspect, using advanced coding techniques, (In-band on-channel) IBOC digital radio supports multiple digital program channels within the bandwidth reserved for the single digital channel audio.

While the VTU is operating the VTU can receive a digital information stream broadcast by a high bandwidth broadcast source, such as SDARS. The VTU can receive the digital information stream while the vehicle is in operation and/or at scheduled times while the vehicle is not in operation. The VTU can monitor the digital data stream for software upgrades for the computers onboard the vehicle. In one aspect, software identification and version information can be contained in a header attached to each a software package in the digital data stream. In some aspect, the software package can be encrypted. In other aspect, the software package can be broadcast without encryption. If the software package is broadcast encrypted, the software can be decrypted at a later time. Once a complete software package is received from the transmitting source, it can be stored in memory coupled to the VTU.

Once a complete software package is received the VTU can validate the contents of the software upgrade contained in the package. The VTU can run a hashing algorithm, such as a CRC, MD5 checksum, and the like, to determine a “check sequence.” Once the check sequence has been determined for the received software upgrade, the VTU can open a communications channel with a central server to verify the software contents. In an aspect, the VTU can open the communications channel with a PCS/Cell Modem.

In an aspect, authenticating the software package can comprise a one-way authentication procedure. For example, a central server can contact the VTU to establish the identity of the central server and relay an authorized software package signature to the VTU. The central server can utilize any of the keys known to both the VTU and the central server to establish the identity of the central server. The VTU can store the software package signature and, upon receipt of the software package, compare the authorized software package signature to the received software package. If the software package signatures match, the VTU can initiate the installation of the software package.

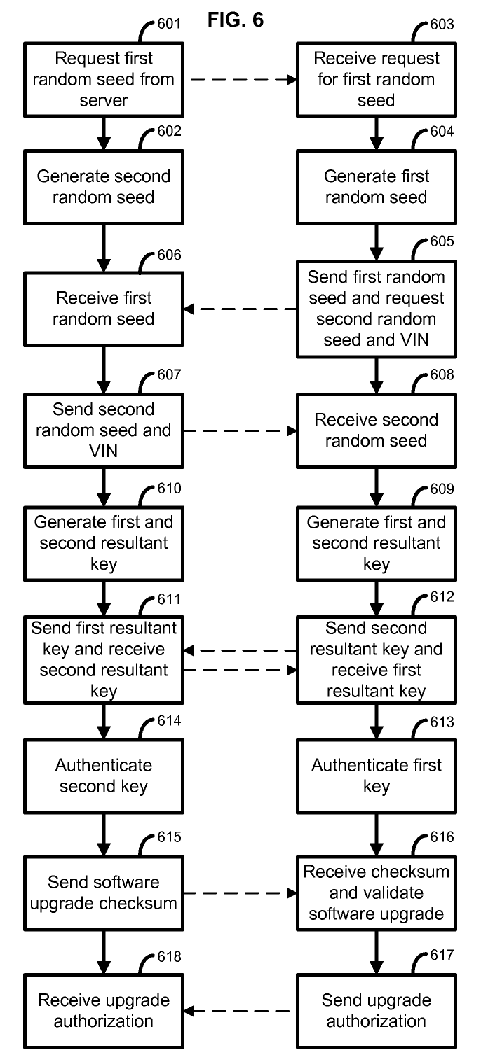

In one aspect, authenticating the software package can comprise a “dual challenge” procedure utilizing secure keys. For example, illustrated in FIG. 6, the VTU can ask the central server (who has knowledge of the secure keys contained within the VTU) for a first random seed at 601. The VTU can generate a second random seed at 602. The central server can receive the request for the first random seed at 603 and generate the first random seed at 604. The central server can send the first random seed and request the second random seed from the VTU and the VIN (or other unique identifier) of the vehicle at 605. The VTU can receive the first random seed at 606 and send the second random seed and the VIN to the central server at 607. The central server can validate that the VIN in question has not actually previously upgraded according to a database of vehicle upgrades. The central server can generate a first resultant key using the first random seed and one of the secure keys for the vehicle based on the VIN and a second resultant key using the second random seed provided by the VTU and one of the secure keys for the vehicle based on the VIN at 609. The VTU can do the same at 610. At 611, the VTU can send the first resultant key to the central server and receive the second resultant key from the central server. At 612, the central sever can send the second resultant key to the VTU and receive the first resultant key from the VTU. At 613, the central server can authenticate the first resultant key and at 614 the VTU can authenticate the second resultant key. Authentication can be CAVE, MD5 or any other similar hashing algorithm. The VTU and the central server thus validate each others computations to ensure that the VTU has established communications with a genuine authorized central server (and not a hack server) and further the central server can validate that it has established communications with the correct vehicle, using the VIN and resultant key.

Once communications have been authenticated, the VTU can forward a computed checksum from the candidate software upgrade at 615. The central server can receive the checksum and validate the software upgrade at 616. If the software is encrypted, the central server can provide a public key (or a key that is mixed with one of the secret keys) to decrypt the software package. In some aspects, if the software package was broadcast to all vehicles, the final decryption key for each can be common. The server can issue a software upgrade command to the VTU at 617. At 618, the VTU can receive the software upgrade authorization.

In another aspect, authenticating the software package can comprise a “dual challenge” procedure utilizing shared secret keys. The VTU can validate that the server is truly the central server operated by the vehicle manufacturer (or other authorized party) and the server can validate that the vehicle to be upgraded is the vehicle targeted for upgrade, that the vehicle includes the hardware in question to be upgraded, and that the older release of the software is contained on the hardware.

In one aspect, the VTU can periodically query one or more hardware modules containing upgradeable software through the CAN bus (or other communications bus). Once a software package is received by the VTU, the VTU can query the hardware module indicated in the software package. The VTU can query the hardware module over the CAN bus (or other communications bus) to determine if the upgrade is required. In another aspect, the VTU can maintain an updated database of hardware modules, associated software, and software versions, thus negating the need to query the hardware modules upon receipt of a software package.

The VTU can initiate a set of communications with the central server to validate subsequent details of the software upgrade. Communications with the central server can comprise the authentication of both parties. Information passed from the VTU can comprise, for example, the VIN, the current software version, and the new software version. If any of this information is incorrect or if authentication fails, the VTU can terminate the software upgrade.

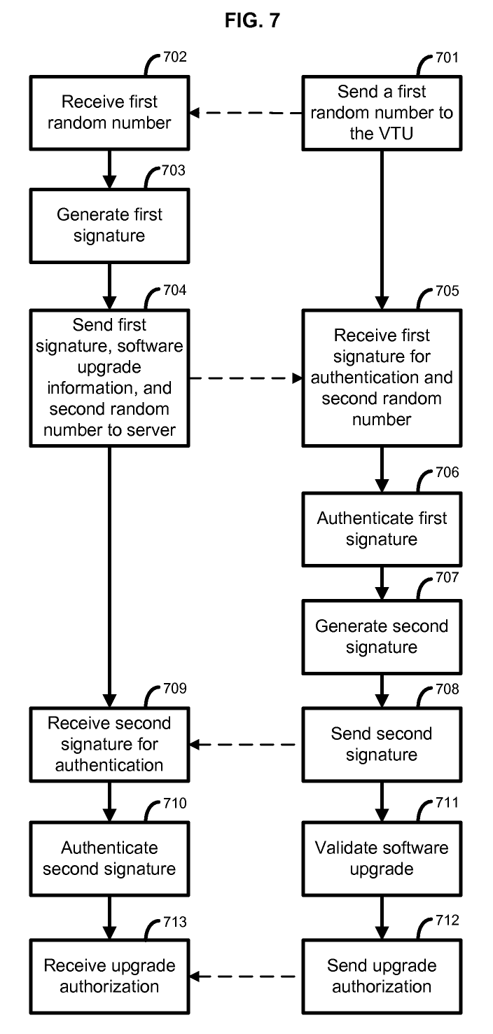

As shown in FIG. 7, upon establishing communications with the server, the server can send a first random number to the VTU with a “server challenge” command at 701. A server challenge can be a command to the VTU to generate a first authentication signature and transmit the first authentication signature and pertinent software upgrade information to the central server. The VTU can receive the first random number and the server challenge command at 702. At 703, the VTU can generate the first authentication signature. In one aspect, the first authentication signature can be generated by the VTU from the first random number, the VTU serial number, a first shared secret key, and the VIN. At 704, the VTU can send the first authentication signature, the VIN, a hardware identifier (identifying the specific hardware module that is to be the subject of the software upgrade), the software upgrade version, an MD5 checksum (or similar) of the received software package, and the current software version to the central server. The VTU can also generate and send a second random number to the central server at 704.

At 705, the central server can receive the first authentication signature and the second random number. The central server can confirm the accuracy of the first authentication signature at 706. At 707, the central server can generate a second authentication signature from the second random number, the VTU serial number, a second shared secret key, and the VIN. The central server can transmit the second authentication signature to the VTU at 708. The VTU can receive the second authentication signature at 709 and confirm the accuracy of the second authentication signature at 710. The software upgrade can be validated at 711 and the central server can issue a software upgrade command to the VTU at 712. At 713, the VTU can receive software upgrade authorization from the central server.

In an aspect, authenticating the software package can comprise communicating via an encrypted data stream. If secure data is passed between the server and the VTU, then it can be encrypted using shared secret keys. For example, the SSD_A and SSD_B keys can be used as an element in the generation of a “secure data key” (SDK). An SDK_A and SDK_B can be determined by the server and by the VTU so that the same message being passed between the units can be encrypted with a different secure data key. The process of calculating SDK_A and SDK_B can be similar to the processes for calculating SSD_A and SSD_B, where the server can pass a random number to the VTU and each can calculate the secure data keys based on the random number, the VTU serial number, and the shared secret key. In one aspect, all communications from the server to the VTU can use SDK_A in a stream cipher algorithm such as Oryx, RC4, Seal, and the like. Further, all communications from the VTU to the server can use SDK_B in a stream cipher algorithm such as Oryx, RC4, Seal, and the like.

The methods can further comprising scheduling when to perform upgrading of the vehicle hardware module. The central server can instruct the VTU when to upgrade the software. Some software upgrades can be accomplished in a matter of seconds and can be handled the next time the car is turned off. If it is necessary to perform an upgrade that will take more than a few seconds, then a scheduling method can be used to determine the best time to schedule the software upgrade. In some aspects, the vehicle can provide a standby light or other indication to the driver that the firmware is being upgraded and to please standby.

Methods are herein provided for when longer upgrades are necessary. In one aspect, provided is a method that comprises a “shadow memory” where the VTU comprises a second memory to accept the software upgrade while the processor is executing from the first memory. The upgrade can happen any time, whether the vehicle is running. At startup, the current software is copied to RAM where it is used for execution. At this time, the storage memory is available for upgrade.

In another aspect, provided is a method that comprises a VTU with a double sized memory array. A hardware latch can toggle between the upper and lower half of the ROM array. An upgrade can occur to one half while the other half is used for execution. Upon completion of the upgrade, the hardware latch can select the upgraded half.

In another aspect, provided is a method wherein the VTU can internally collect an hourly (or any interval) “usage schedule.” For example, the usage schedule can be a bit mapped matrix that has a “1” bit indicating usage during the hour described from the top of the hour through all 60 minutes. If the vehicle is operated during that hour, the hour is tagged with a “1”. If the vehicle is not used, the hour is tagged with a “0”. Each hour of the day can have four bytes associated with it, with each of the 32 bits referencing all usage from yesterday back 32 days.
[00000000]→[00000000]→[00000000]→[00000000] 12:00 MIDNIGHT to 01:00 AM
[00000000]→[00000000]→[00000000]→[00000000] 01:00 AM to 02:00 AM
[00000000]→[00000000]→[00000000]→[00000000] 02:00 AM to 03:00 AM
[00000000]→[00000000]→[00000000]→[00000000] 03:00 AM to 04:00 AM
[00000000]→[00000000]→[00000000]→[00000000] 04:00 AM to 05:00 AM
[00000000]→[00000000]→[00000000]→[00000000] 05:00 AM to 06:00 AM
[00000000]→[00000000]→[00000000]→[00000000] 06:00 AM to 07:00 AM
[00111110]→[01111100]→[11111001]→[11110011] 07:00 AM to 08:00 AM
[00000000]→[00000000]→[00000000]→[00000000] 08:00 AM to 09:00 AM
[10000000]→[10000011]→[00000010]→[00000000] 09:00 AM to 10:00 AM
[01000001]→[00000000]→[00000100]→[00001100] 10:00 AM to 11:00 AM
[00000000]→[00000000]→[00000000]→[00000000] 11:00 AM to 12:00 PM
[00000000]→[00001000]→[00010000]→[11100100] 12:00 AM to 01:00 PM
[00000000]→[00000000]→[00000000]→[00000100] 01:00 PM to 02:00 PM
[00000000]→[00000010]→[00000000]→[00000000] 02:00 PM to 03:00 PM
[00000000]→[00001000]→[00000010]→[00000000] 03:00 PM to 04:00 PM
[00000000]→[00000001]→[00000000]→[00000000] 04:00 PM to 05:00 PM
[00111110]→[01111000]→[11101000]→[10110011] 05:00 PM to 06:00 PM
[00000000]→[00000100]→[00010010]→[01000000] 06:00 PM to 07:00 PM
[01010000]→[00000000]→[00000000]→[00000000] 07:00 PM to 08:00 PM
[00001000]→[00000100]→[00010000]→[00001000] 08:00 PM to 09:00 PM
[00001000]→[00010000]→[00000010]→[00010000] 09:00 PM to 10:00 PM
[00000000]→[00000000]→[00000000]→[00000000] 10:00 PM to 11:00 PM
[00000000]→[00000000]→[00000000]→[00000000] 11:00 PM to 12:00 MIDNIGHT

Each byte can be shifted from the most significant to the least significant until the last bit, referring to the oldest day in question, is discarded. Then the current hour can be shifted into the most significant bit for storage. This computation can be performed when the VTU powers up, updating the usage schedule as necessary to bring it up to date. Alternately, the VTU can power up periodically (once per hour in the example) and update the usage schedule.

Once an upgrade is necessary, the processor can consult the usage schedule to determine the next possible day for upgrade. For example, the schedule can include daily references to allow for a Sunday morning a 3:00 AM upgrade if no other time was clearly available every day for the last 32 days. In another example, the upgrade can be performed after delivering a message on a customer interface (radio head unit, for example) that a software upgrade is necessary and indicated the scheduled software upgrade date and time The message on the customer interface can provide for an estimated time to software upgrade and allow the user to cancel the software upgrade. This allows the customer to cancel the scheduled software upgrade if it would take the automobile out of service for a period of time where the driver expected to use the vehicle. If the driver cancels the software upgrade, the VTU can reschedule the software upgrade, until the driver allowed the software upgrade. In an aspect, once the software upgrade is completed, the VTU can provide a positive confirmation, including a completion status to the central server. The VTU can subsequently remove the software upgrade package from the VTU memory.

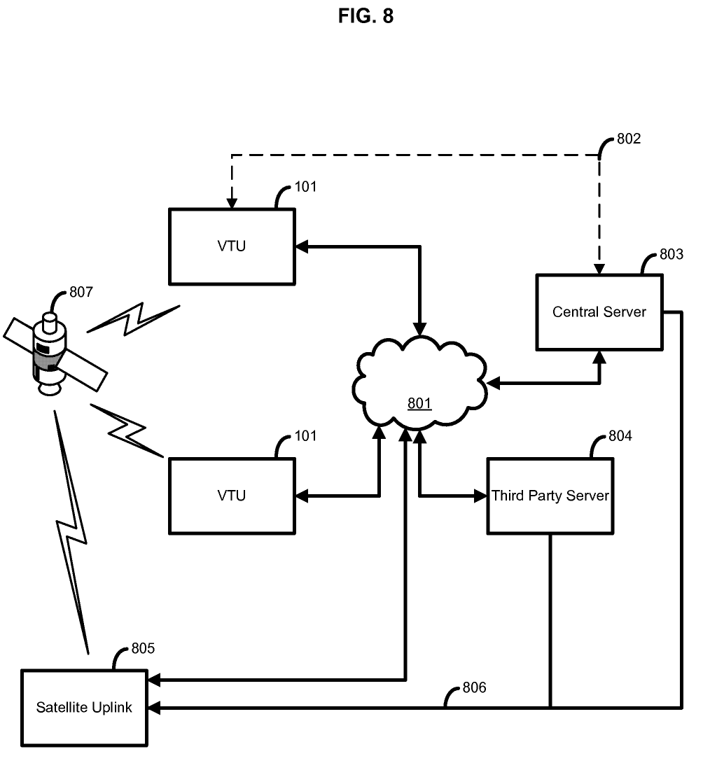

FIG. 8 illustrates an exemplary networked environment wherein the methods and systems disclosed can be practiced. All communication techniques used herein can optionally utilize varying levels of encryption to ensure privacy and prevent fraud. Various components can be in communication via a network such as the wireless network 801 or via direct wireless communication such as short range communication path 802. These communications can take one or more forms of computer communication, for example, electronic mail, data mining, web-browsing, financial transactions, Voice Over IP, any type of data transfer, and the like. Software resident on one or more VTU 101's can communicate with software resident on a central server 803. This communication can facilitate the authentication of both VTU and servers, validation of software upgrades, GPS data, emissions data, diagnostics data, and the like. This communication can be through the wireless network 801 and/or through a short range communication link 802, such as Bluetooth, WiFi, and the like. Central server 803 can maintain a central database of data relating to the one or more VTU 101's, the vehicles within which they are installed, and the software types and versions installed on various vehicle systems. Central server 803 can further analyze the data reported and, in some aspects, send commands and/or other data back to the one or more VTU 101's for further processing. Central server 803 can communicate with software resident on a third party server 804. This communication can facilitate transfer of data to be used by the third party for vehicle recall purposes, accounting purposes, safety purposes, and the like. Central server 803 and/or third party server 804 can be in communication with satellite uplink 805. This communication can be through the wireless network 801 and/or through a direct communication link 806, such as Bluetooth, WiFi, and the like. This communication can facilitate transfer of data such as software updates from the central server 803 and/or third party server 804 to the satellite uplink 805. The satellite uplink 805 can be in communication with one or more satellites 807 to relay data, such as software updates, to one or more VTU 101's.

In some embodiments, software resident one or more VTU 101's can communicate with software resident on one or more of, other VTU 101's, central server 803, and third party server 804. In other embodiments, software resident on central server 803 can communicate with software resident on one or more of, VTU 101's and third party server 804. In further embodiments. software resident on third party server 804 can communicate with software resident on one or more of, VTU 101's and central server 803. In further embodiments, software resident on third party server 804 and/or central server 803 can communicate with software resident on satellite uplink 805. In further embodiments, software resident on satellite uplink 805 can communicate with software resident on one or more satellites 807. In further embodiments, software resident on one or more satellites 807 can communicate with software resident on one or more of, VTU 101's.

The vehicle telematics unit can be configured to perform the methods described herein. The central server can be configured to perform various steps of the methods described herein.

While the methods and systems have been described in connection with preferred embodiments and specific examples, it is not intended that the scope of the methods and systems be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made in the methods and systems without departing from the scope or spirit of the methods and systems. Other embodiments of the methods and systems will be apparent to those skilled in the art from consideration of the specification and practice of the methods and systems disclosed herein. It is intended that the specification and examples be considered as exemplary only, with a true scope and spirit of the methods and systems being indicated by the following claims.

What is claimed is:

1. A method for upgrading software for one, or more, hardware modules of vehicle, comprising:
transmitting an upgraded software file containing upgraded software for one, or more, of the vehicle's electronic control units to a vehicle telematics control unit of the vehicle via a communication network

2. The method of claim 1 further comprising:
performing client portions of an authentication sequence, with the vehicle's telematics control unit being the server in a client-server relationship;
requesting module information from the vehicle's telematics control unit over the communication network;
receiving hardware module information from the vehicle's telematics control unit over the communication network in response to the request;
comparing the module information to corresponding hardware module information in a module tracking table that associates module information with a vehicle identifier; and
transmitting an alert to an interested party if the module information associated with the vehicle in the table does not match the module information received in response to the request for module information.

3. The method of claim 1 further comprising:
requesting module information from the vehicle's telematics control unit over the communication network;
receiving module information from the vehicle's telematics control unit over the communication network in response to the request; and
updating a module tracking table with the module information received in response to the request for module information.

4. The method of claim 1 wherein the communication network is a wireless network.

5. The method of claim 4 wherein the communication network is a cellular network.

6. The method of claim 1 wherein centralized computer equipment at a telematics operation center performs the steps of the method, the centralized computer equipment being coupled to the communication network.

7. The method of claim 2 wherein centralized computer equipment at a telematics operation center coupled to the communication network performs the steps of the method, the equipment being coupled to the communication network.

8. The method of claim 3 wherein centralized computer equipment at a telematics operation center performs the steps of the method, the equipment being coupled to the communication network.

9. The method of claim 2 wherein the interested party is the manufacturer of the vehicle.

10. The method of claim 2 wherein the interested party is a law enforcement agency.

11. The method of claim 1 wherein the authentication sequence includes steps of a two-way random challenge algorithm.

12. The method of claim 1 wherein the unique vehicle identifier is a Vehicle Identification Number (“VIN”).

13. A method for upgrading software in a vehicle, comprising:
receiving an upgraded software file for one, or more, of the vehicle's electronic control units from a communication network with a telematics control unit at the vehicle in communication with the communication network.

14. The method of claim 13 further comprising:
performing server portions of an authentication sequence algorithm with respect to the received upgraded software;
transmitting hardware module information from the telematics control unit over the communication network to computer equipment at a telematics operation center in response to a request for hardware module information, the computer equipment being coupled to the communication network.

15. The method of claim 13 wherein the communication network is a wireless network.

16. The method of claim 13 wherein the communication network is a cellular network.

17. The method of claim 13 wherein the hardware module information includes a model identifier for each of one, or more, hardware modules.

18. The method of claim 13 wherein the hardware module information includes a unique identifier for each of one, or more, hardware modules.

19. The method of claim 13 wherein the authentication sequence includes steps of a two-way random challenge algorithm.

20. The method of claim 19 wherein the two-way random challenge algorithm uses a key known to the telematics control unit and computer equipment coupled to the communication network at a telematics operation center.

21. The method of claim 13 further comprising:
determining whether upgraded software modules contained in the upgraded software file for one, or more, hardware modules installed in the vehicle contain newer software code than currently installed software modules for the corresponding hardware modules; and
upgrading the software of the corresponding hardware modules with upgraded software modules from the upgraded software rile if the results of the authentication sequence indicate that the software was received from a trusted source.

22. A method for creating and updating module information records in a module information table, comprising associating a model identifier and a unique identifier corresponding to each of a plurality of electronic modules in a vehicle with a unique identifier of the vehicle.

23. The method of claim 22 wherein the module information records are created when the vehicle is first turned on following assembly manufacturing of the vehicles.

24. The method of claim 22 wherein the module information records are updated during maintenance activities for a vehicle already having module information associated with it.

25. The method of claim 24 wherein the module information records are updated by receiving hardware module information from a vehicle over a communication network.

26. The method of claim 25 wherein the communication network is a wireless network.

27. The method of claim 26 wherein the wireless network is a cellular network.

28. The method of claim 22 further comprising associating a software module version identifier of software corresponding to a given hardware module with that hardware module.

29. A method for upgrading the software modules of a vehicle's computer system, comprising:
collecting vehicle usage information during a predetermined period;
determining a usage schedule based on the usage information;
determining, based on the usage schedule, a preferred period, or periods, to upgrade the vehicle's software; and
upgrading the software during the preferred period, or periods.

30. The method of claim 29 further comprising storing the usage information into a usage table that stores a value representing usage during each hour of a twenty-four hour period.

31. The method of claim 30 wherein the usage table includes a thirty-two bit number for each hour of the twenty-four hour period, wherein the most significant bit set to one represents usage during the corresponding hour; and wherein the method shifts the thirty-two bit number associated with a given hour of the twenty-four hour period one bit toward the least significant bit so that each time usage during a given hour results in a one being set. in the most significant bit position, the method discards the value in the previously stored least significant bit position.
